(19) United States
(12) Patent Application Publication
(10) Pub. No.: US 2010/0057628 A1
(43) Pub. Date: Mar. 4, 2010

(54) Modular Workflow Management

(75) Inventors: Juan Trinidad, Menlo Park, CA (US); Seth Covitz, San Jose, CA (US); Marcel Prasetya, San Jose, CA (US); Greg Bullock, Bath (GB); Jacobo Tarrio Barreiro, Dublin (IE); Riccardo Govoni, Dublin (IE); Anurag Agrawal, Palo Alto, CA (US)

Correspondence Address: FISH & RICHARDSON P.C., PO BOX 1022, MINNEAPOLIS, MN, 55440-1022, US

(73) Assignee: Google Inc.

(21) Appl. No.: 12/512,516

(22) Filed: Jul. 30, 2009

Related U.S. Application Data
(60) Provisional application No. 61/085,354, filed on Jul. 31, 2008.

(51) Int. Cl. G06Q 10/00

(52) U.S. Cl. 705/301

(57) ABSTRACT

The subject matter of this specification can be embodied in, among other things, a system that includes a container document, a plurality of portable program modules residing in the container document, and a repeater residing in the container document. In addition, at least one of the plurality of portable program modules may be configured to define a communication channel and to identify itself to the repeater as a publisher to the communication channel. Furthermore, at least one of the plurality of portable program modules may be configured to identify itself as a subscriber to the communications channel.

### CROSS-REFERENCE TO RELATED APPLICATION

This application claims priority under 35 U.S.C. §119(e) to U.S. Provisional Application Ser. No. 61/085,354 titled “Modular Workflow Management” filed on Jul. 31, 2008, the disclosure of which is incorporated herein by reference.

### TECHNICAL FIELD

This instant specification relates to workflow management in a business workflow environment, such as in a customer relationship management (CRM) system.

### BACKGROUND

Members of sales teams often interact with clients (and client data) in a variety of different ways. For example, a sales team can include relationship managers who are responsible for handling and growing an overall relationship with a client and account managers who are responsible for handling problems and questions from the client. Such team members may rely on a computer-based customer relationship management (“CRM”) application to assist them in doing their jobs. A CRM application may keep track of information about various clients, such as contact information for clients, lists of tasks that have been performed for the clients, preferences of the clients, amounts that each client has spent on a product or service, and various other information that helps the team better serve clients.

### SUMMARY

In general, this document describes systems and techniques for providing business information such as business workflow information in CRM environments to users of computing devices. In one example, the information is provided using a number of portable program modules such as gadgets or widgets, where the modules can communicate with various data sources in the system and can communicate with each other. A repeater that is instantiated in the same container document, e.g., a web page, as the modules can arbitrate such communication. For example, each module may define a particular communication channel through which it would like to communicate data. Other modules may then subscribe to the channel to receive the data. As one simple example, a first module may employ a user ID to gather the names of all clients served by a user, and may receive a selection of one of the clients from the user. The first module may publish the name of a client each time the user selects a different client. Other modules may be alerted to the change, and may update the data they display to match that for the newly selected client. Communications over the channel may also be stored, so that modules that are activated in the future may be able to obtain the same data.

In this manner, modules can communicate in a business workflow. Each module may represent a sub-process in the workflow, and can announce its state when it finishes with its portion of the workflow. Other modules that are downstream in the workflow may subscribe to a communication channel to which the first module publishes, so that they can be alerted to the state of the process and can perform necessary follow-up processes. Various modules may also limit the other modules that can “hear” their communications so as to help ensure security in the operation of a system.

The systems and techniques described here may provide one or more of the following advantages. First, a system can provide users with customized views of CRM data that best match each user's needs and styles. The customized views can be rearranged easily, and additional modules can be added by a user where appropriate. Also, particular arrangements may be shared between users on a team, so that if one team member develops a particularly helpful system, he or she can share it with others. Also, pre-populated web pages may be provided to team members to display CRM data, and each member may modify the provided pages to better reflect their personal tastes. In addition, users who have slightly different job responsibilities can easily be provided with applications that best match their responsibilities, without having to rewrite an entire system every time a user or group of users wants something changed in the system.

In one implementation, a computer-implemented method for effecting communications in a business workflow is disclosed. The method may comprise generating first and second portable program modules in a container document and generating a repeater in communication with the first and second communication modules. The method may further comprise defining with the first portable program module a communication channel for publishing information in a business workflow, and communicating information about the communication channel to the repeater. The method may also include identifying from the second portable program module to the repeater a communication channel for receiving information from the business workflow and transmitting from the first portable program module information from the business workflow. The method may further include alerting the second portable program module about the information from the business workflow and providing the information about the business workflow in response to a request from the second portable program module.

In another implementation, a system for controlling business workflow communication is disclosed. The system may comprise a container document, a plurality of portable program modules residing in the container document, and a repeater residing in the container document. In addition, at least one of the plurality of portable program modules may be configured to define a communication channel and to identify itself to the repeater as a publisher to the communication channel. Furthermore, at least one of the plurality of portable program modules may be configured to identify itself as a subscriber to the communications channel.

The details of one or more embodiments of the communication features are set forth in the accompanying drawings and the description below. Other features and advantages of the communication features will be apparent from the description and drawings, and from the claims.

### DESCRIPTION OF DRAWINGS

FIG. 1A is a screenshot of a modular CRM system.

FIG. 1B is a screenshot of an example gadget directory page.

FIG. 2 is a conceptual diagram of a business workflow.

FIG. 3 is a conceptual diagram illustrating the integration of gadgets into a container document.

FIG. 4 is a diagram of an inter-gadget communication system.

FIG. 5A illustrates an example process of integrating gadgets into a container document

FIG. 5B is an example process of transmitting information in a business workflow.

FIG. 6 illustrates the flow of communications in an illustrative inter-gadget communication system.

FIG. 7 shows an example of a computer device and a mobile computer device that can be used to implement the techniques described here.

Like reference symbols in the various drawings indicate like elements.

### DETAILED DESCRIPTION

This document describes systems and techniques for modular workflow management in a CRM environment. In general, users of a CRM system may populate a web page with numerous gadgets. Each gadget may be able to communicate its state to other gadgets in the web page. For example, a gadget may establish one or more communication channels and broadcast its state information over the channels. A repeater module may forward this state information to other gadgets that have subscribed to receive these messages. This inter-gadget communication system may allow a user to establish a business workflow where information updated by one gadget may be further processed by other gadgets in a sequential manner. For example, a gadget may contain a list of company names for a user to choose from. After the user selects a company from the list, the gadget may notify other gadgets in the page of the user's choice and these gadgets may update their displays to show information related to that company.

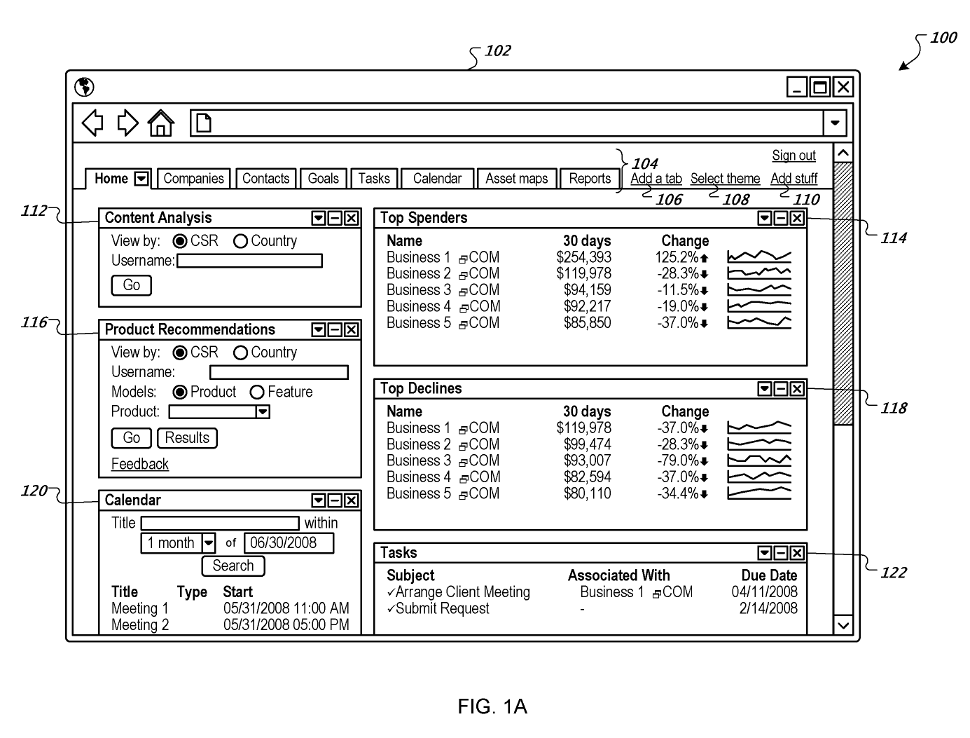

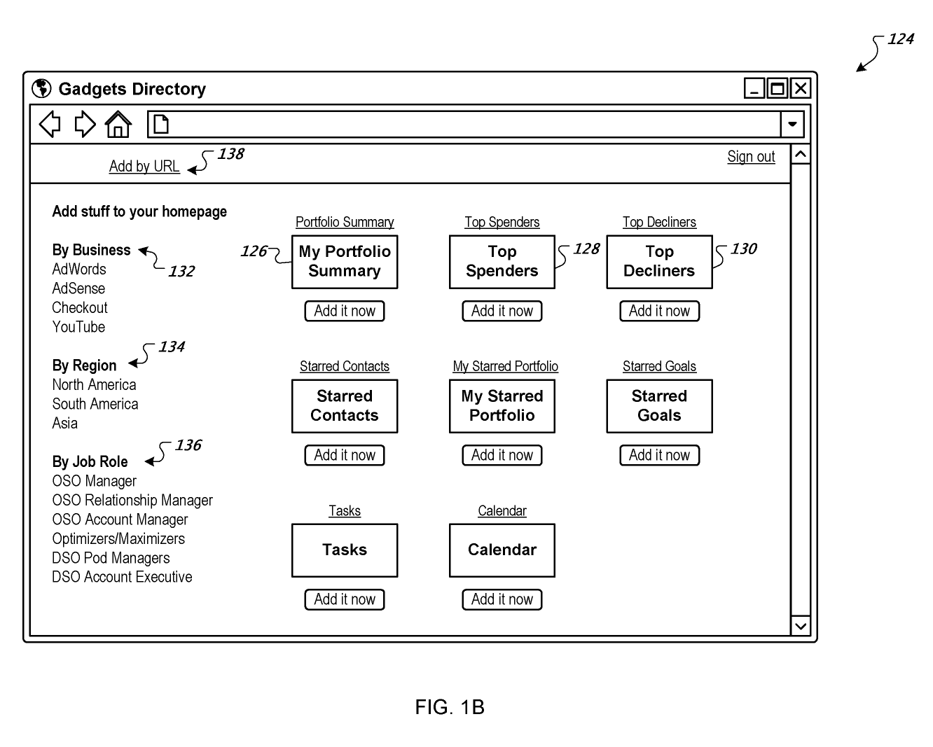

FIG. 1A is a screenshot 100 of a modular CRM system. In the illustrative example, the system may be implemented in a container document 102. The illustrative container document 102 can be an electronic document (e.g., a web page) that allows a user to interact with CRM data stored in a database. The illustrative container document 102 may provide a run-time environment for any number of portable program modules (referred to as gadgets or widgets) such as the Content Analysis 112, Top Spenders 114, Product Recommendations 116, Top Declines 118, Calendar 120, and Tasks 122 gadgets shown in the figure.

Gadgets may comprise various portions of the page, or portions of code for implementing the page. The gadgets may be implemented, for example, in iFrames or other similar elements defined by the container document 102. In some implementations, gadgets may be stand-alone applications. However, gadgets can also be a “window” to another application; i.e., a gadget can provide a view of another (often larger) application and, in some cases, allow a user to interact with the application by manipulating the gadget.

The container document 102 may provide layout and organization management for gadgets. As shown in the screenshot 100, the container document 102 can include numerous tabs 104 that may have one or more associated gadgets. In some implementations, these tabs can be used to organize related gadgets. For example, the illustrative system includes tabs such as Reports and Contacts that can contain gadgets related to client reports and client contacts, respectively. Each tab may have a column layout that the user may adjust by adding columns to a tab or removing columns from a tab. In some implementations, the width and height of the columns may be adjusted by a user. New tabs may be added by clicking the “Add a tab” hyperlink 106. The organization of the container document 102, and the relationship between the container document and the gadgets, may be similar to that for iGoogle pages.

In some implementations, tabs may be shared among users. Sharing tabs may be particularly useful, for example, when a member of a team has developed a page organization that other team members would like to use to enhance their productivity. In some cases, user-created tabs (along with their associated gadgets) may be uploaded to a website where other users can download the tabs and integrate them into their webpage. In some instances, tabs may also be shared through email, instant messenger programs, or other communication mechanisms.

In some implementations, the look and feel of a container document 102 can be set by a theme. In an illustrative example, a theme may determine the graphical appearance of the container document. For example, a theme may determine the colors, buttons, icons, scroll bars, list elements, etc. used in the container document. Like tabs, themes may also be shared among users by posting themes to a website or emailing a theme to another user. In some implementations, users may click on the “Select a theme” hyperlink 108 to choose from preexisting themes or, in some cases, to generate a new theme.

The container document 102 may also facilitate gadget layout and organization by including “drag and drop” functionality, which allows a user to move gadgets to various parts of the document 102 by simply selecting the desired gadget and dragging the gadget to a new location. This may permit users to freely rearrange the gadgets in any layout they choose, without manually modifying the container document code.

In addition to layout and organization, the container document 102 may also provide other services such as security. For example, in some implementations, the container document 102 can support Single Sign On access control so that users can access the container document and its associated gadgets without multiple log ins. The container document may also accept only approved gadgets, e.g., gadgets from a trusted site or from a specified domain.

In some implementations, a default set of pre-configured tabs and gadgets may be presented to a user. For example, the first time a user logs into his webpage, he may see a default set of tabs such as Calendar and Task tabs. These default tabs and gadgets, as well as their settings, may be stored within the container document 102 or on a separate web server. In some implementations, user preferences from another container document may be imported to create the default setting for the current container document. In yet other implementations, the container may automatically populate the container page with randomly selected gadgets, which may present the user with gadgets he may have otherwise not been aware of. In other implementations, the user may be presented a blank container document to which the user may add gadgets.

New gadgets may be added by clicking the “Add stuff” hyperlink 110. In the illustrative example, clicking this hyperlink may cause the browser to navigate to a gadget directory page like the illustrative page shown in FIG. 1B. As shown in FIG. 1B, the illustrative gadget directory page includes several gadget icons such as My Portfolio Summary 126, Top Spenders 128, and Top Declines 130. Gadgets may be separated into one or more categories. In the illustrative gadget directory page show in FIG. 1B, the categories can include Business 132, Region 134, or Job Role 136. Each category can contain a plurality of links, e.g., the Business category may include “AdWords,” “AdSense,” etc. Users may also be able to add gadgets not presented in the gadget directory page. For example, users may be able to add gadgets generally available to the public over the Internet (e.g., weather and news gadgets).

Gadgets corresponding to the icons may be added by clicking the “Add it now” button displayed below each icon. In some implementations, new gadgets can be added to a container document by dragging the gadget from the gadget directory page into the container document. Similarly, in some cases, gadgets can be removed by dragging a gadget currently in a container document outside the bounds of the document.

In some implementations, a gadget may be added to a container document by supplying the gadget's URL. For example, a user may click the “Add by URL” hyperlink 138 and enter the URL that references a gadget to be added to his homepage.

Gadgets may be selected in various manners. For example, a user may enter search keywords, and gadgets having matching keywords assigned by their authors may be returned for selection by the user. Also, a user may select several gadgets that are designed to publish information to various communication channels, and may choose to see all other gadgets that publish to or subscribe to the same communication channels. In this manner, the user can explore options for using data that is generated by their current crop of gadgets. Also, such searching for gadgets designed to accept data from existing gadgets may permit the user to better track their way along a workflow.

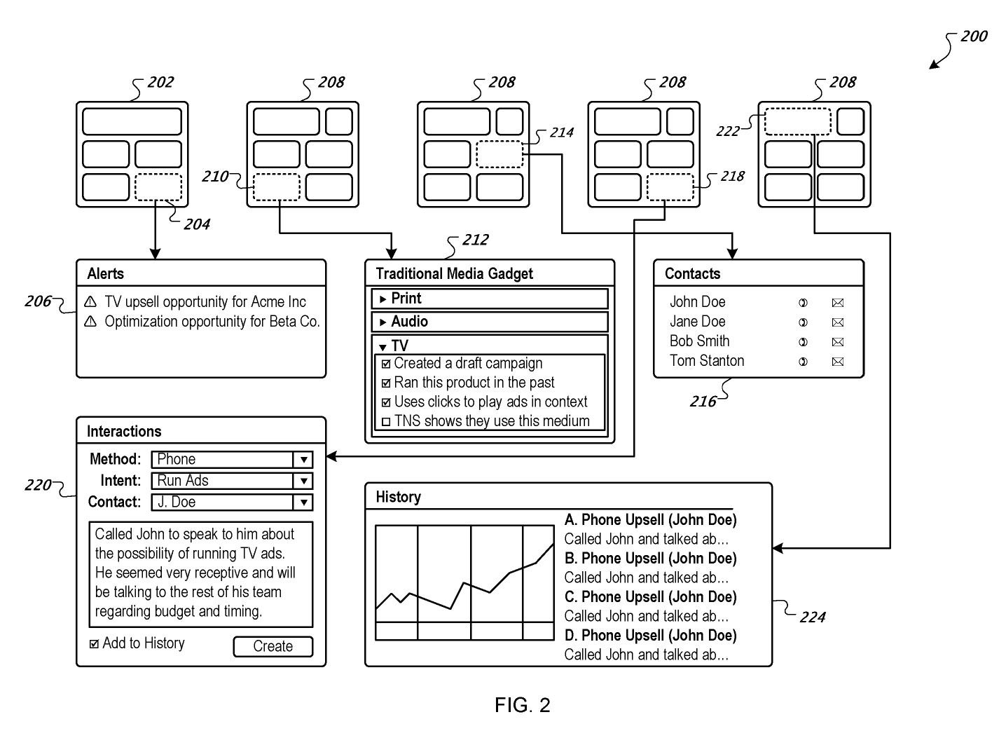

FIG. 2 is a conceptual diagram 200 of a business workflow, shown in relation to gadgets for carrying out the workflow. The illustrative system includes a container document 202 that, in some implementations, may be a webpage such as a user's homepage. The container document 202 may be customized by a user to include gadgets that process selected data. For example, a relationship manager searching for up-sell opportunities (i.e., chances to sell a customer an upgrade or add-on to an existing product or service) may add an alert gadget 204 to his homepage to monitor existing client accounts for indicia that such an opportunity might be available. For example, the gadget 204 may review client account data to see if a client has recently engaged in activity that indicates that the customer may be interested in purchasing a new product or upgrading an existing product.

Continuing the illustrative example, when the relationship manager opens his homepage, the notifications created by the alert gadget 204 are presented to the manager. A window 206 shows two alerts that the gadget 204 has created: “TV up-sell opportunity for Acme Inc.” and “Optimization opportunity for Beta Co.” The illustrative alerts may be hyperlinks that reference another gadget related to the customer account referenced in the link. The gadget may reside in a different gadget in the manager's homepage or, in this example, a gadget in a related container document. For example, if the relationship manager selects “TV up-sell opportunity for Acme Inc.,” the manager's web browser can be directed to the Acme Inc. customer account webpage, which, in this example, is a second container document 208.

Once the relationship manager navigates to the Acme Inc. customer webpage 208, the manager may be presented with several gadgets related to the Acme account. For example, a traditional media gadget 210 may represent traditional media (e.g., Print, Audio, and TV) options for the Acme Inc. account. In the illustrative example, the alert gadget 204 included in the manager's homepage has triggered the traditional media gadget 210 using an inter-gadget communication system discussed in further detail below. In response to the notification provided by the alert gadget 204, the media gadget 210 may display the factors the alert gadget 204 found that make Acme Inc. a good candidate for an up-sell opportunity. As shown in a magnified view 212 of the traditional media gadget 210, in the illustrative example the “Created a draft campaign,” “Ran this product in the past,” and “Uses click to play ads in content” boxes are checked, notifying the manager that these factors led to the alert.

After reviewing the media gadget 210, the relationship manager may want to contact the person at Acme Inc. who handles sales requests, so the manager may refer to a contact gadget 214. In the illustrative example, the contact gadget 214 contains contact information for Acme representatives. As depicted in window 216, the illustrative contact gadget 214 shows the name of the relevant contact person, along with phone and email icons. In this example, these icons initiate either a telephone call or an email, respectively, to the associated contact. In selecting which contacts to display, the contact gadget 214 may obtain notifications from another gadget, such as by receiving a company or account ID and then pulling contact information relating to the ID, in manners described below.

If the relationship manager initiates a telephone call with an Acme representative using the contact gadget 214, the manager may wish to take notes of their conversation for future reference. In the illustrative example, an interaction note gadget 218 may be triggered when the manager calls an Acme representative by clicking on the phone icon included in the contact gadget 214. In addition to allowing the manager to take notes, the illustrative note gadget 218 may record other information about the call. For example, as shown in window 220, the interaction method, intent of call, and the person contacted may be recorded. Such information may be stored automatically in a file associated with the particular contact or account, using information received from the contact manager or another gadget.

Finally, the relationship manager may track the success (or failure) of his sales attempts using a history gadget 222. In this example, the history gadget 222 allows the manager to add flags indicating when he spoke to an Acme representative. As shown in window 224, the history gadget may also track up-sells to Acme over time, giving the relationship manager an indication of whether his efforts had any effect on the amount of money spent by Acme on products or services offered by his sales team.

Each of the steps in the workflow described above may be aided by information passed between the various gadgets shown in the figure. For example, each alert may be associated with a particular account, and selection of a particular alert may cause the alert gadget 206 to notify the other gadgets that the selected account is active. That may, for example, cause the other gadgets, which may be subscribing to a communication channel that announces changes in client or account focus, to update their respective data to show information about the selected client or account. Similar sharing of information between gadgets is discussed below, and may allow a user to work all the way through a business process, with various gadgets being updated throughout the process, and to receive information as they move through the process. Also, certain gadgets may be kept inoperable until appropriate information is available from another gadget, so as to guide a user through a workflow.

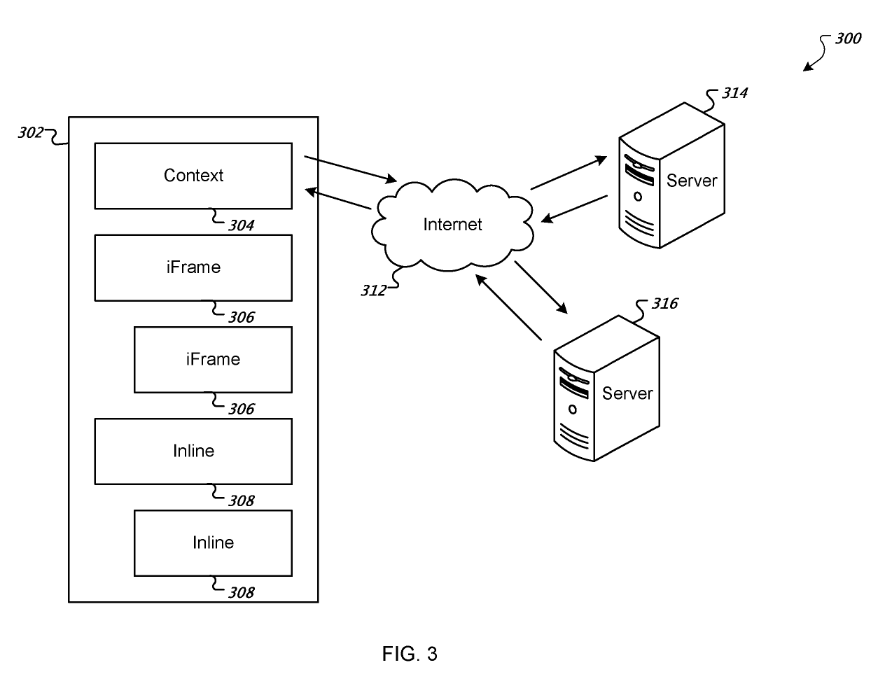

FIG. 3 is a conceptual diagram 300 illustrating the integration of gadgets into a container document 302. In the illustrative example, the container document 302 may contain context data 304 that can be shared by gadgets. Context data 304 may include user preferences for the container document (e.g., user-selected themes and tabs, column layouts, name, etc.), as well as state information saved from previous sessions. The context data may be loaded with the container document 302, or may also be stored centrally where it may be accessed by the gadgets (e.g., by using an ID made available by the container document 302). In addition, the context data 304 may include one or more application programming interfaces (APIs) and software libraries that provide gadget functionality. For example, the context data 304 may include JavaScript libraries and APIs that can allow a gadget to dynamically set its dimensions. In some implementations, the context data 304 may be stored in a web server 314, 316 and later transmitted over the Internet 312 to the container document 302.

As noted above, the container document 302 may include one or more gadgets. In some implementations, gadgets can be implemented in several different ways. For example, one or more gadgets (such as gadgets 308 illustrated in FIG. 3) may be implemented inline, i.e., embedded into the code of the container document 302. Inline gadgets may be more efficient than other types of gadgets because inline gadgets may communicate directly with the container document 302. Inline gadgets may also be able to modify the Document Object Model of the container document 302 and access other gadgets in the container document 302. Thus, in some implementations, only inline gadgets from trusted sources (e.g., a trusted domain such as google.com) may be allowed to execute in the container document.

Unlike the inline gadgets 308, some gadgets may be placed into invisible Inline Frames (iFrames). In general, an iFrame is an HTML document that may be embedded in another HTML document. The document in which an iFrame is embedded, the container document 302 in this example, may be generated around the iFrame while the iFrame is still being generated.

Example HTML code for providing an iFrame in a web page includes the following:

<html>...

```
  <iFrame src=“http://portablecode.com” height=“100”
  width=“200”
```

frameborder=“0” scrolling=“no”>

</iFrame>

....
</html>

As this code shows, the iFrame element may reference a document to be inserted in the iFrame, dimensions for the iFrame, and whether scrolling should be allowed inside the iFrame. The document in the iFrame can be replaced with another document or can be modified or refreshed without refreshing the container document (e.g., the surrounding page), by using the “target” attribute of an HTML anchor or by using JavaScript, such as in an AJAX implementation. Similar displays may be generated, for example, through editing of a document's DOM tree.

After one or more iFrames 306 have been created, one or more gadgets may be loaded into the iFrame. For example, “HTML gadgets” may reside inside iFrames. HTML gadgets may include HTML in their gadget specification, which can be cached by a container document to increase performance. The HTML code that makes up these gadgets may be placed into an iFrame for subsequent display and execution when the iFrame is created.

An iFrame may also contain “URL gadgets.” These gadgets may specify a URL that references the location (e.g., a web server 314, 316) of the content to be placed into an iFrame. The gadget content referenced by the URL may be transmitted to the iFrames 306 when the iFrames 306 are loaded, causing the gadget to be displayed in the container document 302.

URL gadgets may allow the container document 302 to include non-gadget software applications. For example, some users may want to incorporate full page applications or legacy applications into the container document 302. Full-page URL gadgets with minimal or no borders may be placed into the container document 302 and reference the desired application. Because the border associated with the illustrative URL gadget is minimal, the user may not notice that the referenced application is inside a URL gadget.

The gadgets in such a form may be referenced as portable program modules, in that they include or invoke computer program code, are modular in that they can be grouped together in various ways, and are portable in that they can be placed in various documents and are not limited to operation in a particular context. Such form of program modules may be particularly useful where the modules can communicate between and among each other so as to implement a business workflow. The parameters for particular gadgets (e.g., statuses that are controlled and published by a gadget) may be made available to users so that they can determine which other gadgets they might want to include in a workflow. As one example, an up-sell gadget may receive and operate upon a status update from a sales gadget, such as by analyzing what was sold using the sales gadget and then identifying other goods or services that would be useful to a customer who made the initial purchase.

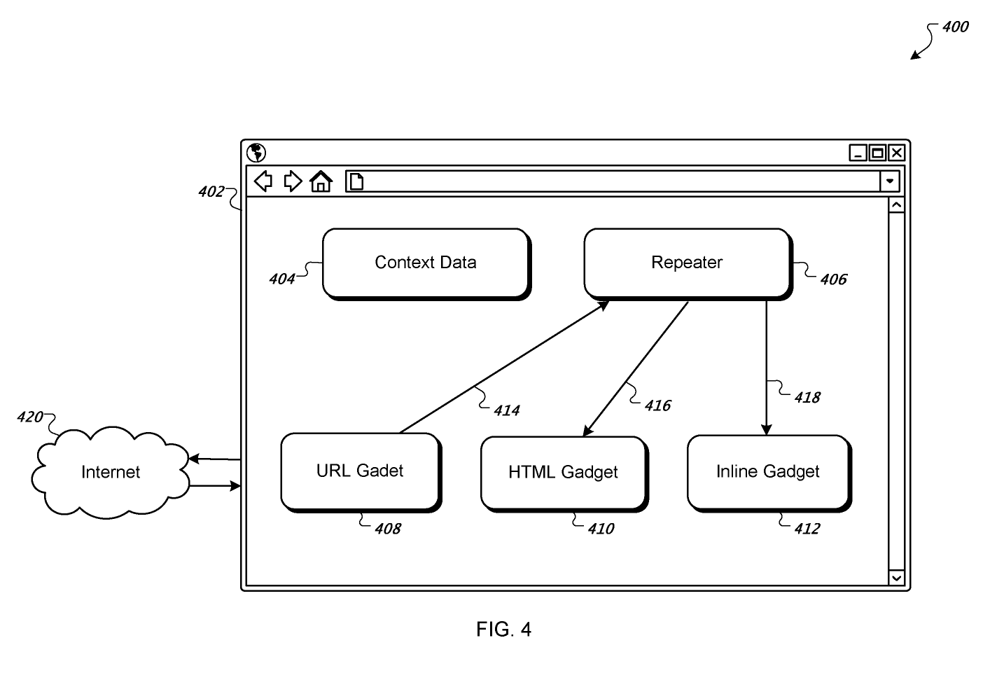

FIG. 4 is a diagram 400 of an inter-gadget communication system 402. The system 402 may permit gadgets to publish information that can then be read by other gadgets so as to permit the construction of a business process workflow across a number of gadgets. A user may easily construct their own workflow by selecting gadgets that can “talk” to each other, and may then share their combinations of gadgets easily with other users if they develop a particularly useful tab or page of gadgets. In the illustrative example, the system 402 may be implemented in a container document such as a webpage stored on and served by a web server. However, in other implementations, the components of the system 402 may be spread across multiple container documents or systems.

The illustrative web page includes gadgets 408, 410, 412 that may communicate with one another by publishing (i.e., broadcasting) messages over communication channels and opting to receive certain messages (i.e., subscribing) from selected channels. In some implementations, a channel may transmit specific types of messages. For example, one channel may be used for communicating data used to test the communication system, while another channel can transmit weather or financial data. Certain actions relating to publishing and subscribing to channels may follow the form of the known GOOGLE PUBSUB system.

In an illustrative implementation, each channel may have a distinctive channel name. Channel names may, in some implementations, adhere to a common naming convention. For example, channel names may be defined according to a hierarchical pattern where hierarchy levels are separated by periods. For example, com.google.container.test may be a valid channel name for test data. In addition, related channels may be part of the same channel hierarchy; these channel hierarchies may be referred to as “trees.” In an illustrative example, channels related to traffic data may be part of the com.google.container.traffic tree, which may include other traffic channels such as com.google.container.traffic.traffic_minneapolis and com.google.container.traffic.traffic_boston.

Gadgets may also subscribe to a sub-tree of channels. For example, a gadget may subscribe to numerous traffic channels by subscribing to the parent of the traffic sub-tree using a wildcard character such as “*.” An exemplary sub-tree channel subscription for the traffic channel is com.google.container.traffic.*. In some implementations, the web page may contain an analysis gadget that monitors broadcasts by other gadgets in the container document and reports on the broadcasts to track time spent by a user performing tasks in a workflow.

In some implementations, gadgets may broadcast messages on any channel. For example, gadgets may broadcast messages on a channel without also subscribing to that channel. In some cases, a channel may subscribe to a sub-tree of channels, and the gadget may broadcast to individual channels.

In some implementations, gadgets may create channels dynamically at run time. For example, a gadget may create a channel by selecting a unique channel name for a particular type of message. For example, a channel may select com.google.container.weather for transmitting weather data. In some implementations, a gadget may add a channel by adding a descriptor for the channel to a root channel name such as com.google.container. An author of a gadget may publish information, such as parameters, for a communication channel so that other gadget authors who would like to obtain information from the first gadget, may author their gadgets appropriately so that they can subscribe to the communication channel and can understand how to use any information that is published to the channel.

In some implementations, gadgets can call APIs to create and communicate with channels. For example, a gadget may include a JavaScript library or a JavaScript library may be provided to the gadget dynamically when the gadget is rendered. Once the gadget has access to the JavaScript library, the gadget can call one or more APIs to create a channel and then communicate with the channel.

The illustrative channels may also be used to broadcast and receive state information regarding the status of gadgets in a business workflow. For example, a gadget may broadcast messages on a status channel indicating when it has received selected data and when it has finished processing the received data. The gadget may also broadcast error messages that not only indicate that an error has occurred, but also identify the type of error and whether the error has caused the workflow to cease. Gadgets may subscribe to status channels so that downstream gadgets may be alerted when an upstream gadget has completed its portion of the workflow. In certain circumstances, a status message may be published to a channel separately from the actual information that may accompany a change in status by a gadget.

In some implementations, gadgets may broadcast and receive a “token” indicating that a gadget can access a shared piece of information. The token may be passed along to another gadget once the current gadget has completed its portion of the workflow. The token may reduce or eliminate collisions between gadgets attempting to simultaneously access the same piece of information. Multiple tokens may also be provided at the same time, so that particular types of information may be restricted to being changed by an associated token bearer, while other types of information can be changed by a bearer of a different token.

The illustrative inter-gadget communication system may include one or more access control lists (“ACLs”) that may specify which channels gadgets can (and cannot) broadcast on or receive messages from. In some implementations, the ACLs may allow gadgets to exchange sensitive information in a secure manner by preventing other gadgets from “hearing” the information. ACLs may be decentralized and contain separate access controls for broadcasting and subscribing to gadgets. For example, an ACL may contain a list detailing which channels a gadget may broadcast to, as well as another list describing which channels a gadget may receive messages from. Each channel may have numerous ACLs associated with it, and in some implementations, a gadget may need permission from each ACL associated with a channel before the gadget can access the channel.

In some implementations, gadgets may create and set ACLs for channels. In some implementations, gadgets may set an ACL on a subset of the available channels, but not all of the available channels. This may prevent a gadget from conducting a denial of service attack by creating an ACL that denies other gadgets access to available channels. In still further implementations, gadgets can create, but not unset or modify existing ACLs. In some cases, a gadget may be able to set ACLs just for the domain that it belongs to; e.g., a google.com gadget may set ACLs for google.com channels.

In some implementations, ACLs may use whitelists and blacklists to control access to channels. In the illustrative example, a gadget may publish or subscribe to a channel if, for that channel, the gadget matches a whitelist entry and does not match any blacklist entries. In some implementations, a gadget's URL may be used to determine if the gadget corresponds to any whitelist or blacklist entries. For example, a gadget's URL can be compared with the list of URLs stored in both the whitelist and the blacklist. The illustrative combination of whitelists and blacklists may permit the system to define both allow-by-default and forbid-by-default access policies.

The illustrative inter-gadget communication system may also include a repeater 406. In some implementations, the repeater 406 may receive messages sent from one gadget and retransmit the received messages to other gadgets located in the same container document or in a different container document. For example, the repeater 406 may, in some implementations, forward messages over the Internet 420 to gadgets in other container documents.

The repeater may also generally control the flow of information in a system, and may be the location to which gadgets go in registering themselves and reporting their actions. As such, the repeater 406 may help to organize communications between and among gadgets and may also provide security in the communications between gadgets, such as by administering ACLs and the like. The repeater may also be provided by code that has been tested by a central provider and that is resistant to attack by gadgets that may be submitted by fraudsters.

The repeater 406 may contain a list of existing channels and a subscription list detailing the channels to which gadgets have subscribed. When the repeater 406 receives a message broadcast on a channel, the repeater 406 may consult the subscription list to determine which gadgets have subscribed to the channel and may forward or transmit the received message to those gadgets. The repeater 406 may also contain a list of all the channels created by a particular gadget. In some implementations, when a gadget subscribes to a channel, the gadget may provide a call back function to the repeater 406 that the repeater 406 can use to forward the message to the gadget.

In some implementations, the repeater 406 may store the ACLs discussed above. The repeater may consult the stored ACLs to determine which channels gadgets may subscribe to or broadcast messages over. As noted above, in some implementations, a gadget may broadcast or subscribe to a channel if it satisfies both a whitelist and a blacklist associated with the one or more ACLs assigned to a channel (i.e., it is on the whitelist and not on the blacklist).

In some implementations, the repeater 406 may also store the latest messages transmitted on a channel. Storing the most recent messages may allow gadgets to retrieve messages transmitted before the gadget subscribed to a channel. This may allow new gadgets to obtain the latest information about the container document and gadgets executing in the document, even if the new gadget did not exist when the relevant messages were sent.

In some cases, gadgets may instantiate a connection software component that provides communication services with the repeater 406. The connection component may contain methods to broadcast and subscribe to channels, as well as set ACLs. The component may also include other methods that allow gadgets to retrieve the latest messages sent to a channel and to determine whether the gadget has permission to broadcast or subscribe to a channel.

As illustrated in FIG. 4, the inter-gadget communication system described above may allow a user to define a business workflow in a CRM system. In some implementations, a user of a CRM system may string together one or more gadgets to accomplish various tasks in a CRM system. For instance, in the illustrative example shown in FIG. 4, a user can place a series of gadgets 408, 410, 412 in a container document 402. The gadgets may access shared context data 404 that contains user preference information as well as APIs and software libraries that the gadgets may use to implement certain gadget features and processes. For example, the shared APIs and libraries may allow gadgets to be grouped in tabs, dynamically change their height, or set the gadget title, among other features.

After accessing the shared context data, the gadgets may be rendered. For example, a URL gadget 408 may obtain its gadget code from a specified web server (not shown) over the Internet 420. The HTML code for a HTML gadget 410 may also be obtained from a specified URL or, in some implementations, the HTML code may stored in the page. The code for an inline gadget 412 may be embedded in the container document. The code for the respective gadgets may be used to create the graphical representation of the gadget manipulated by a user.

In the illustrative example, the URL gadget 408 can begin a business workflow by creating a communication channel 414 that can carry status messages. For example, the URL gadget may create a channel named com.google.status and register the channel with a repeater 406. The HTML 410 and inline 412 gadgets can be alerted to changes in the business workflow process by subscribing to this channel. For example both gadgets 410, 412 may provide a callback function to the repeater 406 that the repeater 406 may use to forward messages transmitted by the URL gadget 408. Once the URL gadget 408 has created the communication channel 414, the gadget can notify the other gadgets that it has begun processing selected data by broadcasting a message on this channel 414. The repeater 406 can forward this message to gadgets that have subscribed to the channel 414, which, in the illustrative example, are the HTML 410 and inline gadgets 412. In some implementations, the messages may be forwarded over separate communication channels 416, 418. Because they have been alerted by the message sent by the URL gadget 408 and forwarded by the repeater 406, the HTML 410 and inline 412 gadgets may avoid manipulating (or attempting to manipulate) data that is currently being accessed by the URL gadget 408.

After the URL gadget 408 has finished processing the selected data, the gadget 408 can broadcast another message indicating that the gadget has finished its sub-process in the workflow. The repeater 406 may forward the message to the HTML 410 and inline 412 gadgets, which can update their respective workflow sub-processes with the processed data. In addition, one of the gadgets may choose to further manipulate the data and broadcast a message indicating that the gadget has accessed the data. For example, once the HTML gadget 410 has received the URL gadget's 408 message that it is no longer processing the selected data, the HTML gadget 410 may broadcast a message indicating that the HTML gadget 410 plans to further manipulate the data. This series of events—broadcasting status messages once a module has started or finished processing data—may be repeated for each module in the business workflow.

The previously mentioned workflow may allow various types of gadget communication. For example, a user of a CRM system may have a “company data” gadget in the user's home page. When the user selects a company in a “company list” gadget, the “company data” gadget may automatically be populated with data from the selected company. Similarly, in some implementations, when a user adds a “company data” gadget to a page where a “company list” gadget already exists, the new “company data” gadget may show the data currently selected in the “company list” gadget. In another illustrative example, if a user of the inter-gadget communication system wants to debug the system, the user may include a gadget that shows all the messages going through the system in real time. These examples are merely illustrative; numerous other business workflows may be created.

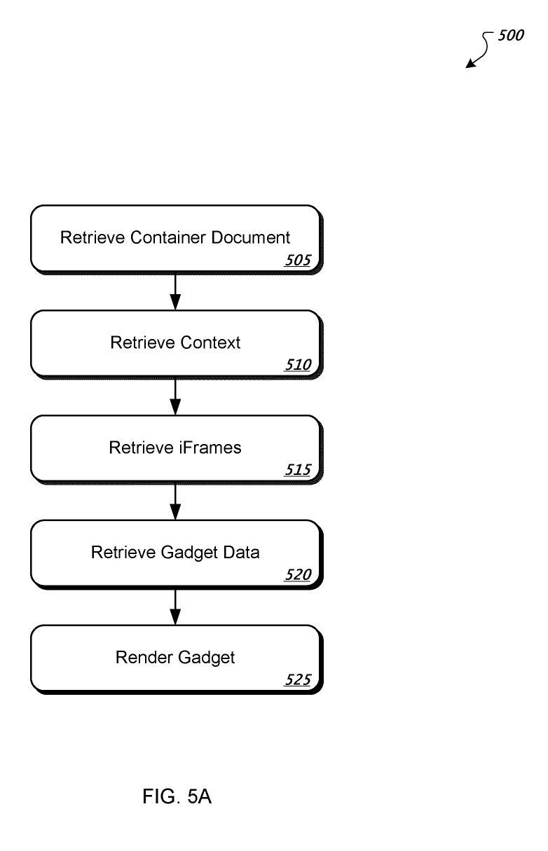

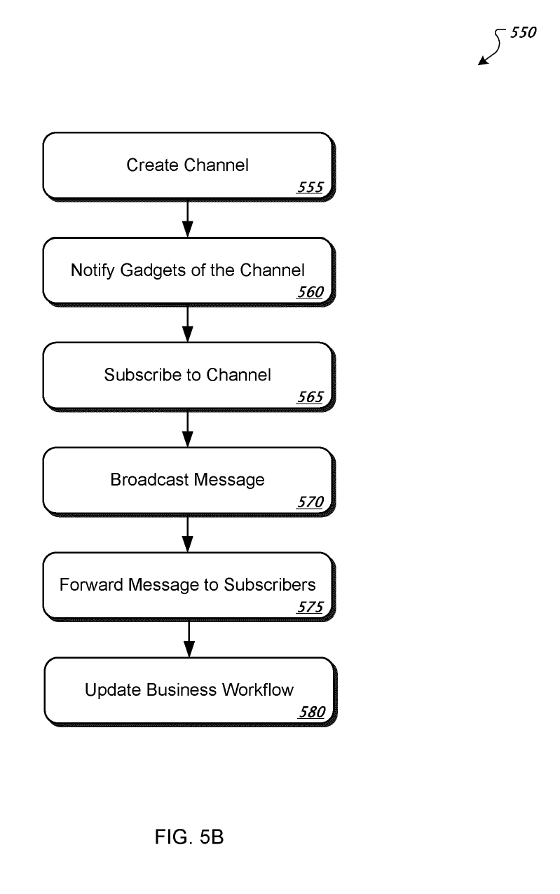

FIGS. 5A and 5B are flow charts of an example process 500 and 550 of integrating gadgets into a container document and transmitting information in a business workflow, respectively. The processes 500 and 550 may be performed, for example, by a system such as the system 400 and, for clarity of presentation, the description that follows uses the system 400 as the basis of an example for describing the processes. However, another system, or combination of systems, may be used to perform the processes 500 and 550.

Referring to FIG. 5A, the illustrative process 500 begins at step 505 when a container document is retrieved. In some implementations, a container document may be stored on a user's computer and may be loaded from the computer's memory. In other implementations, a container document may be stored on a web server and requested by a user by using a web browser.

Once the container document has been obtained, the method proceeds to step 510 where context data is retrieved. In some implementations, the container document 402 may retrieve context data from a web server. In other implementations, the context data may be stored locally in the container document 402. The context data may include APIs, software libraries, and data stored from previous sessions. In some implementations, the context data may also include initialization data used to create a default container document. For example, the context data may contain selected document themes and tabs that may be loaded and used by the container document.

Once the container document 402 receives the context data, one or more iFrames may be obtained at step 515. For example, the container document may retrieve iFrame content for iFrames not already in the container document from one or more web servers. The content may specify, among other things, the position of the iFrame in the page, the dimensions of the iFrame, and a URL that references gadget content to be placed in the iFrame.

Next, gadget data may be retrieved at step 520. For example, as noted above, a URL gadget may supply a URL that references the URL gadget's content. The illustrative URL gadget may pull its gadget content from a web server referenced by the URL. The gadget data of an HTML document may be loaded from the container document or, in some implementations, transmitted from a web server.

Subsequently, at step 525, the gadgets may be rendered. In an illustrative example, a web server may process gadget data to render a gadget. For example, for HTML documents, the web server may produce standard HTML headers, APIs, and software libraries specified by the gadget data and transmit the resulting gadget to the container document. In addition, the web server may replace “placeholder” code with values specified by the gadget data. A similar process may be followed for URL gadgets. Because inline gadgets may already reside in the container document, in some circumstances, the container document may render inline gadgets during the rendering process for the container document. In some implementations, the rendering for HTML and URL gadgets may be performed by the container document.

FIG. 5B is an example process 550 of transmitting information in a business workflow. The illustrative process 550 begins at step 555 where a channel is created. Gadgets may create channels in real time by selecting a valid, unique channel name. As discussed above, channel names may have a common naming protocol. Gadgets may create a channel by selecting a name that conforms to the selected protocol.

The method may proceed to step 560 where gadgets are notified of the new channel. For example, when a gadget creates a channel, a message may be sent to the other gadgets (through the repeater 406) notifying these gadgets that a new channel exists. In some implementations, the message may request that selected gadgets subscribe to the channel. For example, a gadget allowing users to select a company from a list of companies may request that related gadgets (e.g., gadgets that display company contact information, purchasing history, etc.) subscribe to the gadget's newly created channel.

Gadgets may subscribe to the channel at step 565. As noted above in regards to step 560, some gadgets may subscribe to a channel in response to a subscription request from another gadget. Gadgets may also periodically scan a list of current channels maintained by the repeater 406 and subscribe to channels based on various criteria. For example, a gadget may subscribe to channels that have been added to a channel hierarchy to which the gadget has already subscribed, channels that contain a specified keyword, etc.

Next, gadgets may broadcast a message over the newly created channel at step 570. For example, a gadget may broadcast a message to a repeater 406 indicating that it is currently accessing data or has performed a function. A gadget may also broadcast a message specifying its capabilities or characteristics. For example, a gadget displaying a user's clients may publish a message notifying other gadgets that it has this feature. A related gadget, e.g., a gadget that analyzes sales data and displays trends in a company's purchasing habits, may subscribe to channels created by the list gadget so that it can update its display in response to a user selecting a company in the list gadget.

Following the broadcast of a message to the repeater 406, the message may be forwarded to subscribing gadgets at step 575. For example, the repeater 406 may consult an internal list specifying which gadget has subscribed to the channel that the message was broadcast on and transmit the message to all of the gadgets on the list.

Once the message has been forwarded, the business workflow may be updated at step 580. For example, gadgets downstream of the gadget that broadcast the forwarded message may update their processes and displays in accordance with the message. For example, once an upstream gadget that allows a user to select a company name broadcasts a message specifying which company was selected, downstream processes may update their displays to reflect information relevant to the selected company.

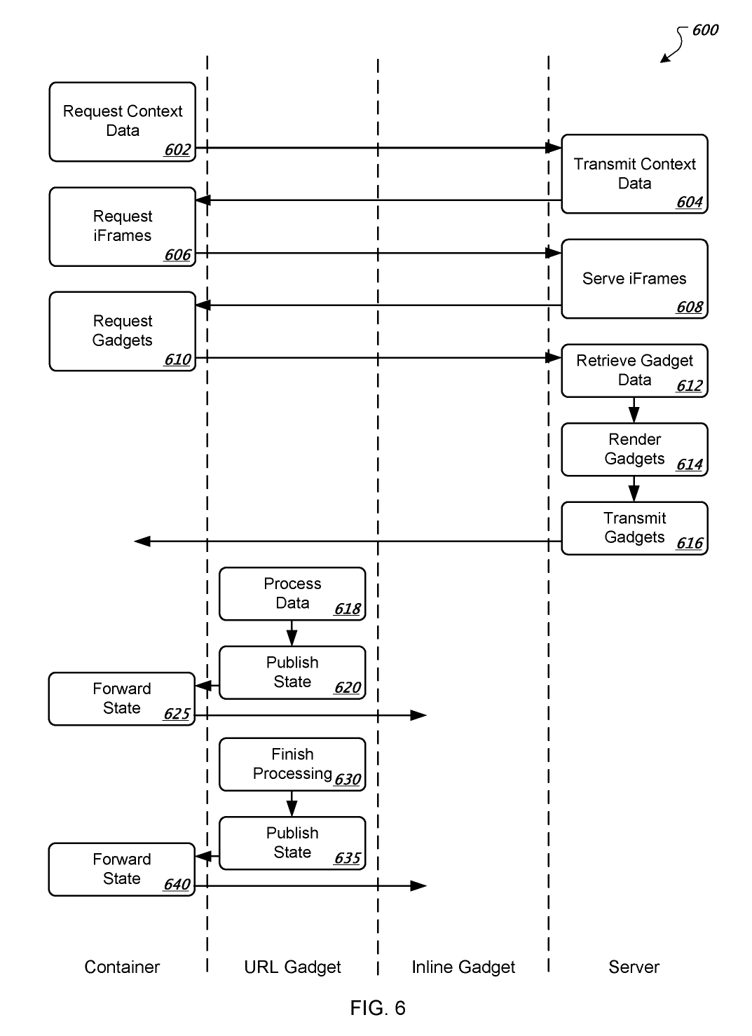

FIG. 6 illustrates the flow of communications in an illustrative inter-gadget communication system. In the illustrative system, a container document may request context information from a server at step 602. In response, the server may transmit the requested context information to the container document at step 604. As noted above, the context information may include APIs, software libraries (e.g., JavaScript), and previous session information.

After receiving the requested context data, the container document may request one or more iFrames at step 606. As noted above, an iFrame may be a HTML document that may be embedded in another HTML document using an iFrame element. In response to the request for an iFrame, the server may return the requested iFrame at step 608.

Subsequently, the container document may request one or more gadgets from the server at step 610. In response the server, may retrieve the gadget data used to render the gadgets from local memory (or from another server) at step 612. After the server has retrieved the gadget data, the server may render the gadgets at 614 and transmit the rendered gadgets to the container document at step 616.

The rendered gadgets may be used to implement a business workflow. For example, a URL gadget may process selected CRM data at step 618 and broadcast a message indicating its current state (e.g., that the gadget is accessing the selected data) to a repeater at step 620. The repeater may forward the message to other gadgets (e.g., an inline gadget) that have subscribed to the communication channel at step 625. A similar series of steps may occur when the gadget finishes processing the data at step 630. For example, the gadget may broadcast a message indicating that it has finished its processing task at step 635 and the repeater may forward that message to the subscribed inline gadget at step 640.

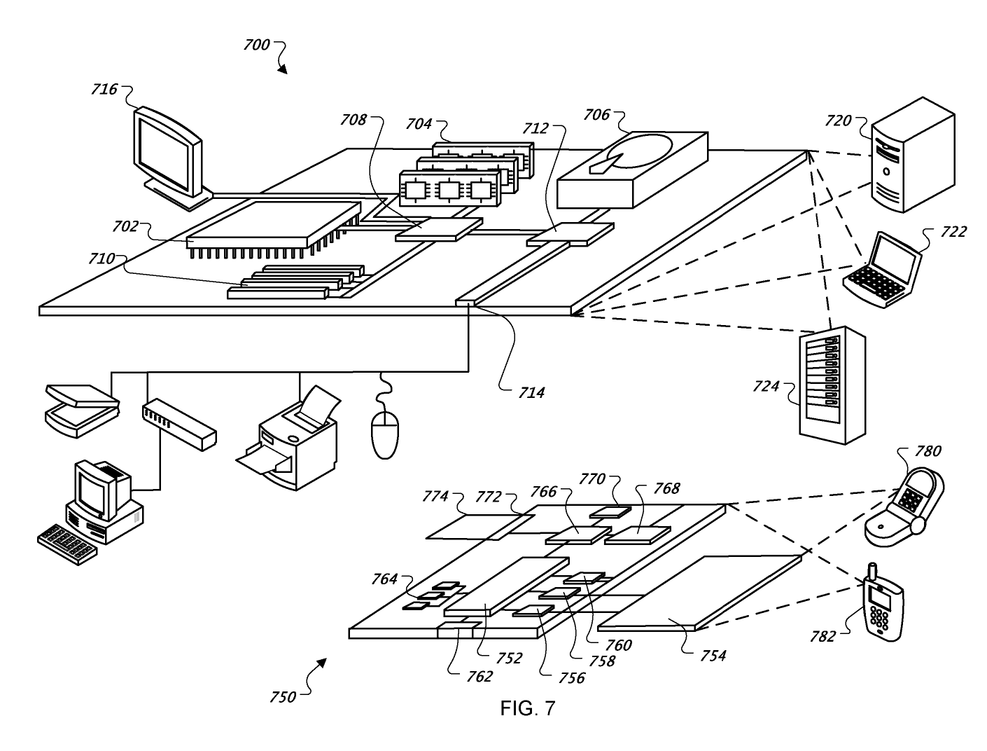

FIG. 7 shows an example of a computer device 700 and a mobile computer device 750 that can be used to implement the techniques described here. Computing device 700 is intended to represent various forms of digital computers, such as laptops, desktops, workstations, personal digital assistants, servers, blade servers, mainframes, web servers and other appropriate computers. Computing device 750 is intended to represent various forms of mobile devices, such as personal digital assistants, cellular telephones, smartphones, and other similar computing devices. The components shown here, their connections and relationships, and their functions, are meant to be exemplary only, and are not meant to limit implementations of the inventions described and/or claimed in this document.

Computing device 700 includes a processor 702, memory 704, a storage device 706, a high-speed interface 708 connecting to memory 704 and high-speed expansion ports 710, and a low speed interface 712 connecting to low speed bus 714 and storage device 706. Each of the components 702, 704, 706, 708, 710, and 712, are interconnected using various busses, and may be mounted on a common motherboard or in other manners as appropriate. The processor 702 can process instructions for execution within the computing device 700, including instructions stored in the memory 704 or on the storage device 706 to display graphical information for a GUI on an external input/output device, such as display 716 coupled to high speed interface 708. In other implementations, multiple processors and/or multiple buses may be used, as appropriate, along with multiple memories and types of memory. Also, multiple computing devices 700 may be connected, with each device providing portions of the necessary operations (e.g., as a server bank, a group of blade servers, or a multi-processor system).

The memory 704 stores information within the computing device 700. In one implementation, the memory 704 is a volatile memory unit or units. In another implementation, the memory 704 is a non-volatile memory unit or units. The memory 704 may also be another form of computer-readable medium, such as a magnetic or optical disk.

The storage device 706 is capable of providing mass storage for the computing device 700. In one implementation, the storage device 706 may be or contain a computer-readable medium, such as a floppy disk device, a hard disk device, an optical disk device, or a tape device, a flash memory or other similar solid state memory device, or an array of devices, including devices in a storage area network or other configurations. A computer program product can be tangibly embodied in an information carrier. The computer program product may also contain instructions that, when executed, perform one or more methods, such as those described above. The information carrier is a computer- or machine-readable medium, such as the memory 704, the storage device 706, memory on processor 702, or a propagated signal.

The high speed controller 708 manages bandwidth-intensive operations for the computing device 700, while the low speed controller 712 manages lower bandwidth-intensive operations. Such allocation of functions is exemplary only. In one implementation, the high-speed controller 708 is coupled to memory 704, display 716 (e.g., through a graphics processor or accelerator), and to high-speed expansion ports 710, which may accept various expansion cards (not shown). In the implementation, low-speed controller 712 is coupled to storage device 706 and low-speed expansion port 714. The low-speed expansion port, which may include various communication ports (e.g., USB, Bluetooth, Ethernet, wireless Ethernet) may be coupled to one or more input/output devices, such as a keyboard, a pointing device, a scanner, or a networking device such as a switch or repeater, e.g., through a network adapter.

The computing device 700 may be implemented in a number of different forms, as shown in the figure. For example, it may be implemented as a standard server 720, or multiple times in a group of such servers. It may also be implemented as part of a rack server system 724. In addition, it may be implemented in a personal computer such as a laptop computer 722. Alternatively, components from computing device 700 may be combined with other components in a mobile device (not shown), such as device 750. Each of such devices may contain one or more of computing device 700, 750, and an entire system may be made up of multiple computing devices 700, 750 communicating with each other.

Computing device 750 includes a processor 752, memory 764, an input/output device such as a display 754, a communication interface 766, and a transceiver 768, among other components. The device 750 may also be provided with a storage device, such as a microdrive or other device, to provide additional storage. Each of the components 752, 764, 754, 766, and 768, are interconnected using various buses, and several of the components may be mounted on a common motherboard or in other manners as appropriate.

The processor 752 can execute instructions within the computing device 750, including instructions stored in the memory 764. The processor may be implemented as a chipset of chips that include separate and multiple analog and digital processors. The processor may provide, for example, for coordination of the other components of the device 750, such as control of user interfaces, applications run by device 750, and wireless communication by device 750.

Processor 752 may communicate with a user through control interface 758 and display interface 756 coupled to a display 754. The display 754 may be, for example, a TFT (Thin-Film-Transistor Liquid Crystal Display) display or an OLED (Organic Light Emitting Diode) display, or other appropriate display technology. The display interface 756 may comprise appropriate circuitry for driving the display 754 to present graphical and other information to a user. The control interface 758 may receive commands from a user and convert them for submission to the processor 752. In addition, an external interface 762 may be provide in communication with processor 752, so as to enable near area communication of device 750 with other devices. External interface 762 may provide, for example, for wired communication in some implementations, or for wireless communication in other implementations, and multiple interfaces may also be used.

The memory 764 stores information within the computing device 750. The memory 764 can be implemented as one or more of a computer-readable medium or media, a volatile memory unit or units, or a non-volatile memory unit or units. Expansion memory 774 may also be provided and connected to device 750 through expansion interface 772, which may include, for example, a SIMM (Single In Line Memory Module) card interface. Such expansion memory 774 may provide extra storage space for device 750, or may also store applications or other information for device 750. Specifically, expansion memory 774 may include instructions to carry out or supplement the processes described above, and may include secure information also. Thus, for example, expansion memory 774 may be provide as a security module for device 750, and may be programmed with instructions that permit secure use of device 750. In addition, secure applications may be provided via the SIMM cards, along with additional information, such as placing identifying information on the SIMM card in a non-hackable manner.

The memory may include, for example, flash memory and/or NVRAM memory, as discussed below. In one implementation, a computer program product is tangibly embodied in an information carrier. The computer program product contains instructions that, when executed, perform one or more methods, such as those described above. The information carrier is a computer- or machine-readable medium, such as the memory 764, expansion memory 774, memory on processor 752, or a propagated signal that may be received, for example, over transceiver 768 or external interface 762.

Device 750 may communicate wirelessly through communication interface 766, which may include digital signal processing circuitry where necessary. Communication interface 766 may provide for communications under various modes or protocols, such as GSM voice calls, SMS, EMS, or MMS messaging, CDMA, TDMA, PDC, WCDMA, container document 102MA2000, or GPRS, among others. Such communication may occur, for example, through radio-frequency transceiver 768. In addition, short-range communication may occur, such as using a Bluetooth, WiFi, or other such transceiver (not shown). In addition, GPS (Global Positioning System) receiver module 770 may provide additional navigation- and location-related wireless data to device 750, which may be used as appropriate by applications running on device 750.

Device 750 may also communicate audibly using audio codec 760, which may receive spoken information from a user and convert it to usable digital information. Audio codec 760 may likewise generate audible sound for a user, such as through a speaker, e.g., in a handset of device 750. Such sound may include sound from voice telephone calls, may include recorded sound (e.g., voice messages, music files, etc.) and may also include sound generated by applications operating on device 750.

The computing device 750 may be implemented in a number of different forms, as shown in the figure. For example, it may be implemented as a cellular telephone 780. It may also be implemented as part of a smartphone 782, personal digital assistant, or other similar mobile device.

Various implementations of the systems and techniques described here can be realized in digital electronic circuitry, integrated circuitry, specially designed ad servers ASICs (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

These computer programs (also known as programs, software, software applications or code) include machine instructions for a programmable processor, and can be implemented in a high-level procedural and/or object-oriented programming language, and/or in assembly/machine language. As used herein, the terms “machine-readable medium” “computer-readable medium” refers to any computer program product, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term “machine-readable signal” refers to any signal used to provide machine instructions and/or data to a programmable processor.

To provide for interaction with a user, the systems and techniques described here can be implemented on a computer having a display device (e.g., a CRT (cathode ray tube) or LCD (liquid crystal display) monitor) for displaying information to the user and a keyboard and a pointing device (e.g., a mouse or a trackball) by which the user can provide input to the computer. Other kinds of devices can be used to provide for interaction with a user as well; for example, feedback provided to the user can be any form of sensory feedback (e.g., visual feedback, auditory feedback, or tactile feedback); and input from the user can be received in any form, including acoustic, speech, or tactile input.

The systems and techniques described here can be implemented in a computing system that includes a back end component (e.g., as a data server), or that includes a middleware component (e.g., an application server), or that includes a front end component (e.g., a client computer having a graphical user interface or a Web browser through which a user can interact with an implementation of the systems and techniques described here), or any combination of such back end, middleware, or front end components. The components of the system can be interconnected by any form or medium of digital data communication (e.g., a communication network). Examples of communication networks include a local area network (“LAN”), a wide area network (“WAN”), and the Internet.

The computing system can include clients and servers. A client and server are generally remote from each other and typically interact through a communication network. The relationship of client and server arises by virtue of computer programs running on the respective computers and having a client-server relationship to each other.

A number of embodiments have been described. Nevertheless, it will be understood that various modifications may be made. For example, various forms of the flows shown above may be used, with steps re-ordered, added, or removed. Also, although several applications of the content delivery systems and methods have been described, it should be recognized that numerous other applications are contemplated. Accordingly, other embodiments are within the scope of the following claims.

What is claimed is:

1. A computer-implemented method for effecting communications in a business workflow, comprising:
generating, at a computer system, first and second portable program modules in a container document;
generating a repeater in communication with the first and second communication modules;
defining with the first portable program module a communication channel for publishing information in a business workflow, and communicating information about the communication channel to the repeater;
identifying from the second portable program module to the repeater a communication channel for receiving information from the business workflow;
transmitting from the first portable program module information from the business workflow; and
alerting the second portable program module about the information from the business workflow and providing the information about the business workflow in response to a request form the second portable program module.

2. The method of claim 1, further comprising generating a plurality of portable program modules that subscribe to the communication channel for receiving information from the business workflow.

3. The method of claim 1, wherein the container document is a web page.

4. The method of claim 1, further comprising providing, from the second portable program module to the repeater, a call back function that causes the repeater to notify the second portable program module when a message is posted to the communication channel for receiving information from the business workflow.

5. The method of claim 5, wherein the call back function identifies a subtree of a plurality of channels.

6. The method of claim 1, wherein the repeater administers access control limitations for providing messages to portable program modules that subscribe to a channel.

7. The method of claim 6, wherein the repeater applies access control limitations from multiple portable program modules to a single communications channel.

8. The method of claim 6, further comprising generating, by the first portable program module, an access control limitation definition for use by the repeater in controlling access to messages from the first portable program module published on the communications channel for publishing information in the business workflow.

9. The method of claim 1, wherein the repeater tests a portable program module against a whitelist and a blacklist before providing access to a message.

10. The method of claim 9, wherein the test is conducted against a URL for the portable program module.

11. The method of claim 1, further comprising receiving from a user of a computing device an update to data in the first portable program module, and publishing the update to the communication channel for publishing information in a business workflow, wherein publishing the update to the communication channel for publishing information in the business workflow includes publishing a state indicator for the business workflow.

12. The method of claim 11, further comprising using the state indicator to control use of the update to the communication channel for publishing information in the business workflow by portable program modules that subscribe to the communication channel for publishing information in the business workflow.

13. The method of claim 1, further comprising saving, with the repeater, the information from the business workflow to make the information from the business workflow available in the future to portable program modules that subscribe to the communication channel for receiving information from the business workflow.

14. The method of claim 1, wherein the second portable program module comprises an analysis module that monitors publications by other modules in the container document and reports on the publications to track time spent by a user performing tasks in the workflow.

15. A computer-implemented system for controlling business workflow communication, comprising:
a container document;
a plurality of portable program modules residing in the container document; and
a repeater residing in the container document;
wherein at least one of the plurality of portable program modules is configured to define a communication channel and to identify itself to the repeater as a publisher to the communication channel, and at least one of the plurality of portable program modules is configured to identify itself as a subscriber to the communications channel.

16. The system of claim 15, further comprising providing, from a subscriber to the repeater, a call back function that causes the repeater to notify the subscriber when a message is posted to the communication channel.

17. The system of claim 15, wherein the repeater administers access control limitations for providing messages to portable program modules that subscribe to a channel.

18. A computer-implemented system for controlling business workflow communication, comprising:
a container document;
a plurality of portable program modules residing in the container document; and
means for managing coordination of communications among the plurality of portable program modules defining a business workflow.

19. The system of claim 18, wherein the container document is a web page.

20. The system of claim 18, wherein the repeater administers access control limitations for providing messages to portable program modules that subscribe to a channel.
